(19) United States
(12) Patent Application Publication
(10) Pub. No.: US 2023/0398918 A1
(43) Pub. Date: Dec. 14, 2023

(54) TABLE SYSTEM

(71) Applicant: LCI ITALY S.R.L., Florence (IT)

(72) Inventors: Francesco TATINI, FIorence (IT); Francesco CAVINI, Florence (IT)

(21) Appl. No.: 18/209,573

(22) Filed: Jun. 14, 2023

(30) Foreign Application Priority Data
Jun. 14, 2022 (IT) 202022000002456

(51) Int. Cl. B60N 3/00; A47B 13/02; A47B 13/00

(52) U.S. Cl. CPC B60N 3/001; A47B 13/021; A47B 13/003

(57) ABSTRACT

A table system for means of transport includes a supporting surface, a frame supporting the supporting surface, the frame having a beam, and connecting structure designed to stably connect the frame at least to one between a wall and a floor of a means of transport. The beam has a central body with longitudinal extension and at least a first portion curved at 90°.

### CROSS-REFERENCES TO RELATED APPLICATIONS

This application claims priority of Italian Utility Model Application No. 202022000002456 filed Jun. 14, 2022, the entire content of which is hereby incorporated by reference in this application.

### BACKGROUND

This invention relates to a table system for a means of transport.

In particular, the invention relates to a table system which can be advantageously applied in a railway carriage.

Many means of transport, often railway carriages but even some buses, currently have tables amongst the passenger seats designed to support small objects, such as mobile phones, tablets and portable computers, but also drinks, books, magazines or the like.

A quite widespread seating configuration is that of having four seats in opposite pairs, that is to say, two facing the direction of travel and the other two facing in the opposite direction, with a table between them designed to support the above-mentioned items.

Other configurations include tables, with a more limited size, facing only two passengers.

According to prior art solutions there are tables having a supporting surface supported by a relative leg fixed on the floor and, if necessary, a further supporting bracket connected to a wall.

The above-mentioned leg and, where present, the wall-mounted bracket, are designed to guarantee a stable support for the supporting surface of the table, which performs structural functions.

This circumstance, that is to say, the fact that the supporting surface is also required to carry out main structural functions, relative to the retaining of the table in its entirety, means that the constraints imposed on designers in the design of new interior furnishings for railway carriages or means of transport in general are high.

In other words, since the supporting surface of the table has to guarantee predetermined levels of mechanical performance and structural strength, these constraints often constitute exceptional limitations which are difficult to overcome by the designers.

### SUMMARY

An aim of the described embodiments is to provide a table system which is able to overcome the drawbacks of the prior art and which is at the same time practical to install and simple and inexpensive to make.

A further aim of the described embodiments is to provide a table system for means of transport which offers great versatility and allows the adoption of many supporting surfaces.

According to the described embodiments, these aims and others are achieved by a table system for means of transport comprising the technical features described in the accompanying claims.

### BRIEF DESCRIPTION OF THE DRAWINGS

The technical features of the described embodiments, with reference to the above-mentioned aims, are clearly described in the appended claims and its advantages are apparent from the detailed description which follows, with reference to the accompanying drawings which illustrate non-limiting example embodiments, in which:

FIG. 1 is a schematic perspective view from above of an embodiment of a table system for means of transport according to the described embodiments;

FIG. 2 is a schematic perspective view from above of a variant embodiment of the table system for means of transport according to the described embodiments;

FIG. 3 is a schematic side elevation view of a further variant embodiment of the table system for means of transport according to the described embodiments;

FIG. 4 is a schematic perspective view, with some parts cut away to better illustrate others, of the table system of FIG. 1;

FIG. 5 is a schematic perspective view, with some parts cut away to better illustrate others, of the table system of FIG. 2;

FIG. 6 is a schematic perspective view, with some parts cut away to better illustrate others, of the table system of FIG. 3; and

FIG. 7 is a schematic side elevation view of the table system of FIG. 5.

### DETAILED DESCRIPTION

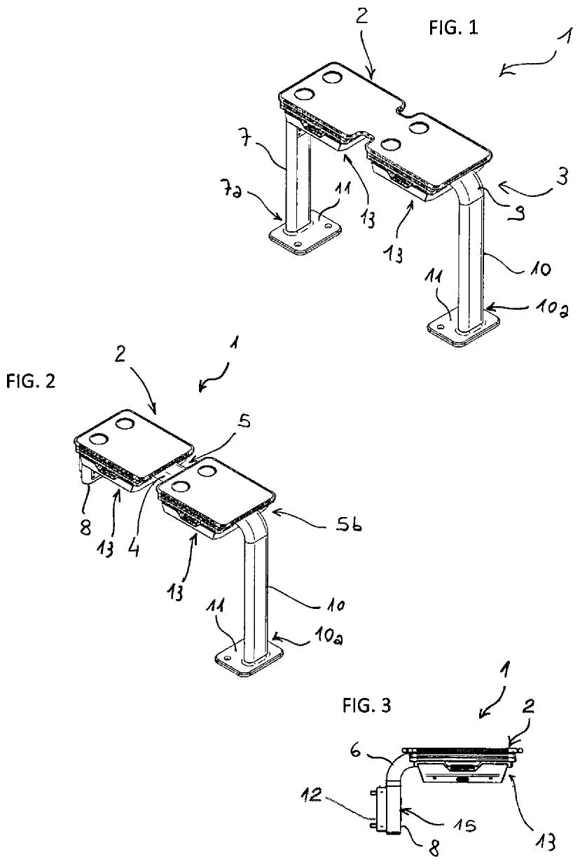

With reference to FIGS. 1 to 6, the numeral 1 denotes in its entirety, according to its different embodiments, a table system for means of transport, not illustrated, made in accordance with the described embodiments.

The table system 1 for means of transport, hereinafter for brevity also referred to simply as the table system 1 comprises a supporting surface 2 and a frame 3 supporting the supporting surface 2.

As illustrated by way of example in FIGS. 1 and 2, the supporting surface 2 may be made in one or more parts and also comprise, not illustrated in detail, extendable or openable portions to be extracted as required.

In other words, the supporting surface 2 may be made in a single body, as shown in the embodiment of FIG. 1, or it may comprise a plurality of separate elements, as illustrated in the embodiment of FIG. 2.

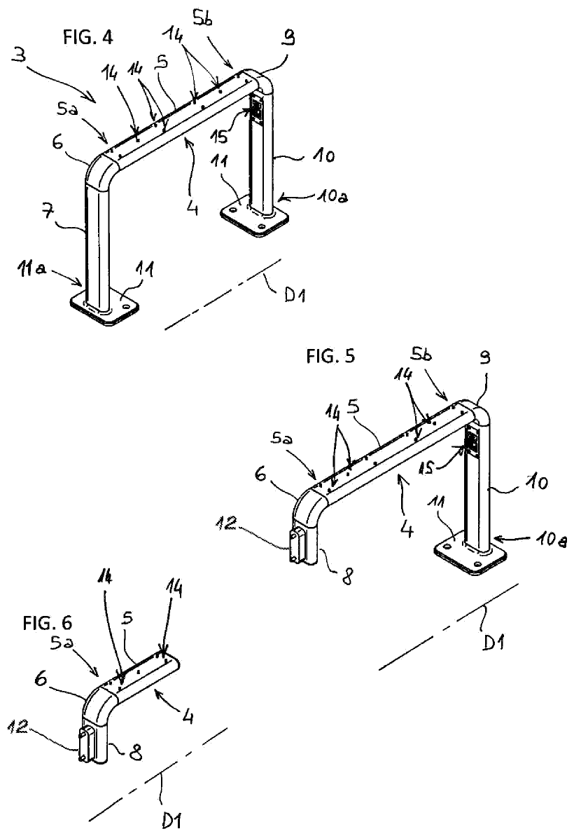

As shown in FIGS. 4 to 6, which show respective views of three relative alternative embodiments, the above-mentioned frame 3 comprises a beam 4 extending along a predetermined direction D1.

Preferably, the above-mentioned predetermined direction D1 is transversal to a defined advancement direction of the above-mentioned and not illustrated means of transport.

Again with reference to FIGS. 4 to 6, the beam 4 has a central body 5 extending longitudinally along the above-mentioned predetermined direction D1 and a first portion 6 curved at 90°, located at a first end 5a of the above-mentioned central body 5.

The above-mentioned supporting table 2 is connected to the supporting frame 3 at the central body 5 of its beam 4.

With reference to FIGS. 1 to 6, the supporting frame 3 of the table system 1 according to its embodiments illustrated comprises, at the above-mentioned first portion 6 curved at 90°, either a first leg 7 for resting on the floor or a portion 8 against a wall.

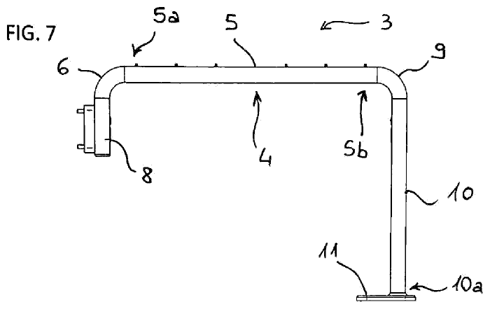

More in detail, the embodiment of the table system 1 illustrated in FIGS. 1 and 4 shows the supporting frame 3 which has, at the above-mentioned first portion 6 curved at 90°, a first leg 7 resting on the floor. Alternatively, the embodiments of the table system 1 illustrated, respectively, in FIGS. 2, 5, 7 and 3, 6 have, at the above-mentioned first portion 6 curved at 90°, a portion 8 against the wall.

With reference to the embodiments of the table system 1 of FIGS. 1, 4 and 2, 5, 7, the beam 4 has a second portion 9 curved at 90°, positioned at a second end 5b of the central body 5, longitudinally opposite the above-mentioned relative first end 5a.

Advantageously, the above-mentioned beam 4 is made from a metal profile.

The first and second portions 6, 9, curved at 90° of the beam 4, are obtained by plastic deformation of the metal profile section.

Again with reference to the two embodiments of FIGS. 1, 4 and 2, 5, 7, the relative supporting frame 3 comprises, connected to and extending from the above-mentioned second portion 5b curved at 90°, a respective second leg 10 resting on the floor.

Basically, the embodiment illustrated in FIGS. 1 and 4 has two legs 7, 10. resting on the floor.

The embodiment illustrated in FIGS. 2, 5 and 7 has a first leg 7 for resting on the floor and a portion 8 against the wall.

The embodiment illustrated in FIGS. 3 and 6 comprises only a portion 8 against a wall.

With reference to the embodiments having one or two legs 7, 10 resting on the floor, at a lower end 7a, 10a of the leg 7, 10, the supporting frame 3 comprises a base plate 11 configured to be screwed to a floor, not illustrated, of a above-mentioned, and also not illustrated, means of transport.

The above-mentioned base plate 11 is stably connected to the respective leg 7, 10 of the supporting frame 3.

With reference to the embodiments having a portion 8 against the wall, that is to say, those illustrated in FIGS. 2, 3 and from 5 to 7, the supporting frame 3 comprises an anchoring bracket 12, stably connected to the portion 8 against a wall and configured to be fixed to a wall, not illustrated, of an above-mentioned and also not illustrated means of transport.

The above-mentioned base plate 11 and anchoring bracket 8 define, for the table system 1, connecting means designed to stably connect the supporting frame 3 to either a wall or a floor, not illustrated, of a means of transport, also not illustrated.

Advantageously, the first and second legs 7, 10 are also made from a metal profile with respective longitudinal channels.

Advantageously, the base plate 11 is stably connected to the respective leg 7, 10 of the frame 3 by fixing means, not illustrated, screwed in the above-mentioned and not illustrated longitudinal channels made in the metal profile with which the legs 7, 10 are made.

Advantageously, as illustrated in FIGS. 1 to 3, the table system 1 according to the described embodiments comprises, fixed below the beam 4, casing 13 for housing objects, made like a drawer.

As illustrated in FIGS. 4 to 6, the central body 5 of the beam 4 has a plurality of through holes 14 made in it designed to allow the supporting surface 2 to be fixed to the frame 3 by easily inserting screws from a lower face of the beam 4 itself, without offering the user the view of the table system 1.

As illustrated in the accompanying drawings, the table system 1 according to the described embodiments comprises an electricity charging socket 15 positioned on one or both of the above-mentioned legs 7, 10 resting on the floor and/or on the portion 8 against the wall. Advantageously, a respective recharging socket 15 is positioned at both longitudinal ends of the beam 4, at least when the table system 1 is designed for four users. The table system according to the described embodiments achieves the preset aims and brings important advantages.

Advantageously, the fact that both the beam 4 and the legs 7, 10 are made from a profile section means that technical wiring ducts are formed in that profile, intended both to power the above-mentioned electricity charging sockets 15 and any other electrical operating means not further described.

Advantageously, the profile from which the above-mentioned beam 4 and legs 7, 10 are made is a metal profile made of an aluminium alloy.

A first of these advantages is due to the fact that by adopting an autonomous frame the designers are free to make the supporting surface with the most diverse and varied forms and materials, as there are no structural constraints.

Another advantage connected to the table system according to the described embodiments is due to its versatility since it is easily configurable both for wall-mounted and floor-mounted fixing.

1. A table system for means of transport, comprising:
a supporting surface,
a frame for supporting said supporting surface, said frame comprising a beam,
connecting means designed to stably connect said frame at least to one between a wall and a floor of a means of transport, wherein said beam has a central body extending longitudinally and at least a first portion curved at 90° located at a first end of said central body.

2. The table system according to claim 1, wherein said beam is made from a metal profile section and said first portion which is curved at 90° is made by plastic deformation of said metal profile section.

3. The table system according to claim 1, wherein said frame comprises, at said first portion curved at 90°, either a leg resting on the floor or a portion against a wall.

4. The table system according to claim 1, wherein said beam has a second portion curved at 90°, located at a second end of said central body, longitudinally opposite said relative first end.

5. The table system according to claim 4, wherein said frame comprises, connected to and extending from said second portion curved at 90°, a respective leg resting on the floor.

6. The table system according to claim 3, wherein said connecting means comprise at least one base plate configured to be screwed to a floor of said means of transport, said base plate being stably connected to a respective leg of said supporting frame.

7. The table system according to claim 6, wherein respective longitudinal channels are made inside said leg, wherein said base plate is stably connected to said respective leg of said frame by fixing means which are screwed into said longitudinal channels.

8. The system according to claim 3, wherein said supporting frame comprises a portion against a wall, wherein said connecting means comprise an anchoring bracket, stably connected to said portion against a wall and configured to be fixed to a wall of a means of transport.

9. The table system according to claim 3, wherein it comprises at least one electricity charging socket positioned on said leg resting on the floor and/or on said portion against the wall.

10. The table system according to claim 2, wherein technical wiring ducts are formed inside said profile.

11. The table system according to claim 1, wherein said supporting surface is connected to said supporting frame at said central body of said beam.

12. The table system according to claim 2, wherein said profile of said beam is made of an aluminium alloy.

13. The table system according to claim 1, wherein said supporting surface is made as a single body.

14. The table system according to claim 1, wherein said supporting surface comprises a plurality of separate members.

15. The table system according to claim 1, wherein said supporting surface comprises elements which can be opened.

16. The table system according to claim 3, wherein each support leg is made as a single body with said beam.
